(19) United States
(12) Patent Application Publication
(10) Pub. No.: US 2021/0373375 A1
(43) Pub. Date: Dec. 2, 2021

(54) Electrically Actuated Privacy Glass Panel System

(71) Applicant: Goldray Industries, Inc., Calgary (CA)

(72) Inventors: Michael Saroka, Calgary (CA); Prince Ruchogeza, Calgary (CA)

(21) Appl. No.: 17/330,750

(22) Filed: May 26, 2021

Related U.S. Application Data
(60) Provisional application No. 63/030,015, filed on May 26, 2020.

(51) Int. Cl. G02F 1/1347; G02F 1/13; G02F 1/1335

(52) U.S. Cl. CPC G02F 1/13471; G02F 1/133528; G02F 1/1323

(57) ABSTRACT

A privacy panel system is disclosed, and comprises a privacy panel. The privacy panel comprises a first conductive layer, a second conductive layer, and a transmittance layer between the first conductive layer and the second conductive layer. The transmittance layer has a transmittance that is responsive to an electrical field between the first conductive layer and the second conductive layer. A first conductor is electrically connected to the first conductive layer, and a second conductor is electrically connected to the second conductive layer. While the electrical field is applied across the transmittance layer, the transmittance layer has a uniform transmittance.

### TECHNICAL FIELD

The present disclose relates to a privacy glass panel system, in particular, to a privacy glass panel system having a transmittance layer with uniform transmittance while electrically actuated.

### BACKGROUND

A glass panel may be used as a window, as a wall, or as a partition, for a room. The glass panel may be installed in a room in order to, for example, introduce light into the room, or to provide a line of sight through the glass panel and between the inside of the room and the outside of the room. It may be desirable, at times, to obscure the line of sight between the inside of the room and the outside of the room, for example, to provide privacy.

One way to obscure the line of sight is to use a privacy panel, such as a polymer-dispersed liquid crystal (PDLC) privacy panel. In response to an electrical field applied across the PDLC layer of the privacy panel, a clear line of sight through the privacy panel may be present, such that the privacy panel may appear translucent. In the absence of an electrical field across the PDLC layer, a clear line of sight through the privacy panel may be absent, such that the privacy panel may appear opaque.

Various PDLC privacy panels have been developed. The disposition of the electrical connections of existing PDLC privacy panels may be limited to the top edge portion. The electrical connections of existing PDLC privacy panels may not be disposed on the bottom edge portion because the frame of the privacy panel may be designed to sit on the floor to support the privacy panel, such that the frame may impede access to the wires and it may be a challenge to pull wires from the bottom of the privacy panel. In addition, existing privacy panels may not have an opening at the bottom of the frame that is insulated and sufficiently wide for wires to be pulled through while complying with electrical codes for safety. Improper pulling of wires from the bottom of the privacy panel, for example, pulling the wires out, may irreparably damage the privacy panel, such that the electrical connections may not be disposed on the bottom edge portion in order to reduce the risk of irreparable damage to the privacy panel. Further, the electrical connections may not be disposed on the side edge portion because the glass panels and frame may not define a channel of sufficient depth, for example, at least 12 mm or 0.5″, to receive the electrical connections. Moreover, if the privacy panels are installed in a butt-joint system, where the side edge portion of the privacy panels are abutted against each other, the electrical connections may not be disposed on the side edge portion of the privacy panel, as the electrical connections may not be obscured from view by the adjoining privacy panels. In addition, the wires, which may be conventional electrical wires encased in a conduit, may not be disposed on the side edge portion of the privacy panel as they may impede the abutment of the two privacy panels along opposing edges.

Unfortunately, such limitation of the disposition of the electrical connections to the top edge portion of the existing privacy panels may result in haziness of the privacy panel, which may be due to an inconsistent application of the electrical field across the PDLC layer of the privacy panel. That is, a portion of the privacy panel more proximate to the electrical connections may appear clear, while a portion of the privacy panel more distant from the electrical connections may appear hazy. This may be undesirable, as the user may want a line of sight to be present through the hazy or opaque portion of the privacy panel. Such haziness may also be aesthetically unpleasant.

In addition, due to an inconsistent application of the electrical field across the PDLC layer of existing privacy panel, the size of existing privacy panels are limited, and may not be used for applications requiring larger privacy panels.

### SUMMARY OF THE DISCLOSURE

In one aspect, there is provided a privacy panel system, comprising: a privacy panel, comprising: a first conductive layer; a second conductive layer; a transmittance layer between the first conductive layer and the second conductive layer, the transmittance layer having a transmittance that is responsive to an electrical field between the first conductive layer and the second conductive layer; a first conductor electrically connected to the first conductive layer; a second conductor electrically connected to the second conductive layer; wherein the first conductor, the first conductive layer, the second conductor, the second conductive layer, and the transmittance layer are co operatively configured such that, while the electrical field is applied across the transmittance layer, the transmittance layer has a uniform transmittance.

In another aspect, there is provided a privacy panel system, comprising: a privacy panel, comprising: a first conductive layer, a second conductive layer, a transmittance layer between the first conductive layer and the second conductive layer, the transmittance layer having a transmittance response to an electrical field between the first conductive layer and the second conductive layer; a first conductor electrically connected to the first conductive layer; a second conductor electrically connected to the second conductive layer; the first conductor, the first conductive layer, the second conductor, and the second conductive layer are co operatively configured to generate a uniform electrical field between the first conductive layer and the second conductive layer.

In another aspect, there is provided a privacy panel system, comprising: a privacy panel including a continuous privacy panel portion and a viewing surface; the continuous privacy panel portion including an operative viewing surface portion of the viewing surface; the continuous privacy panel portion configurable in a first configuration and a second configuration; an electrical field generator; wherein: while the continuous privacy panel portion is disposed in the first configuration, the continuous privacy panel portion has a first uniform transmittance; while the continuous privacy panel portion is disposed in the second configuration, the continuous privacy panel portion has a second uniform transmittance; the transition between the first configuration and the second configuration is effectible in response to a change in the electrical field; and a surface area of the operative viewing surface portion defines at least 90% of a total surface area of the viewing surface.

In another aspect, there is provided a method of using a privacy panel system, the privacy panel system comprising a privacy panel that comprises a first conductive layer, a second conductive layer, a transmittance layer between the first conductive layer and the second conductive layer, the transmittance layer having a transmittance that is responsive to an electrical field between the first conductive layer and the second conductive layer, a first conductor electrically connected to the first conductive layer, a second conductor electrically connected to the second conductive layer, the method comprising: applying a potential to the first and second conductive layers to generate an electrical field across the transmittance layer, such that the transmittance layer has a uniform transmittance.

Other aspects will be apparent from the description and drawings provided herein.

### BRIEF DESCRIPTION OF DRAWINGS

In the figures, which illustrate example embodiments,

FIG. 1 is an elevation view of an embodiment of a privacy panel system;

FIG. 2 is a schematic of the privacy panel of the privacy panel system of FIG. 1;

FIG. 3 is a cross-sectional view of the privacy panel of the privacy panel system of FIG. 1;

FIG. 4 is an elevation view of the privacy panel system with first and second conductors extending along edge portions of the privacy panel system.

FIG. 5 is an elevation view of the privacy panel;

FIG. 6 is an elevation view of a transmittance layer of the privacy panel; and

FIG. 7 is an elevation view of two joined privacy panels.

### DETAILED DESCRIPTION

A privacy panel system is disclosed. The privacy panel system includes a privacy panel that has a first conductive layer, a second conductive layer, and a transmittance layer between the first and second conductive layers. The privacy panel system further includes a first conductor that is electrically connected to a first conductive layer of the privacy panel, and a second conductor that is electrically connected to a second conductive layer of the privacy panel. The first and second conductors are configured to define a voltage therebetween, such that an electrical field is applied across the transmittance layer in response to a voltage between the first and second conductors. The first conductor, the first conductive layer, the second conductor, the second conductive layer, and the transmittance layer are co-operatively configured such that, while the electrical field is applied across the transmittance layer, the transmittance layer has a uniform transmittance. While the electrical field is generated between the first conductive layer and the second conductive layer, the difference in transmittance between two spaced-apart regions of the transmittance layer is visibly indiscernible, for example, to the naked eye.

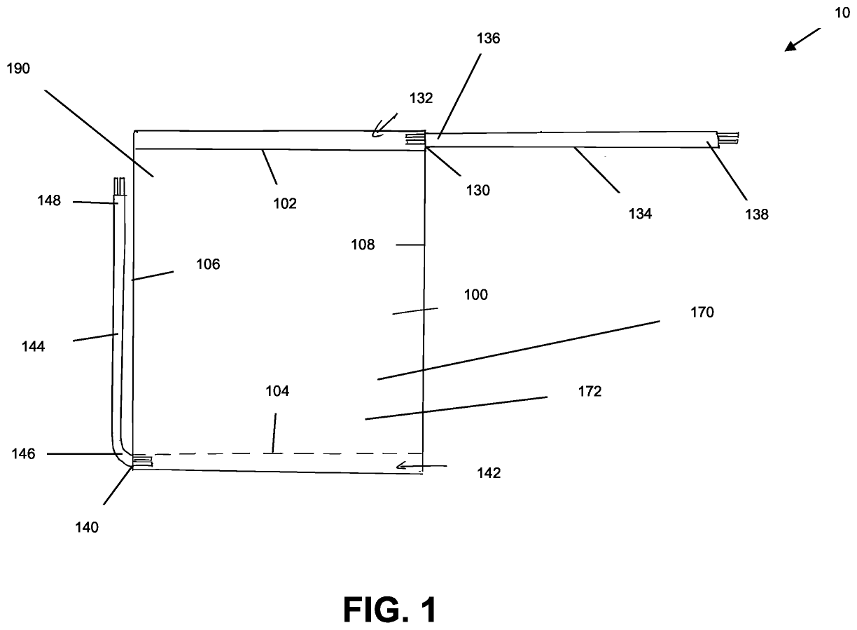

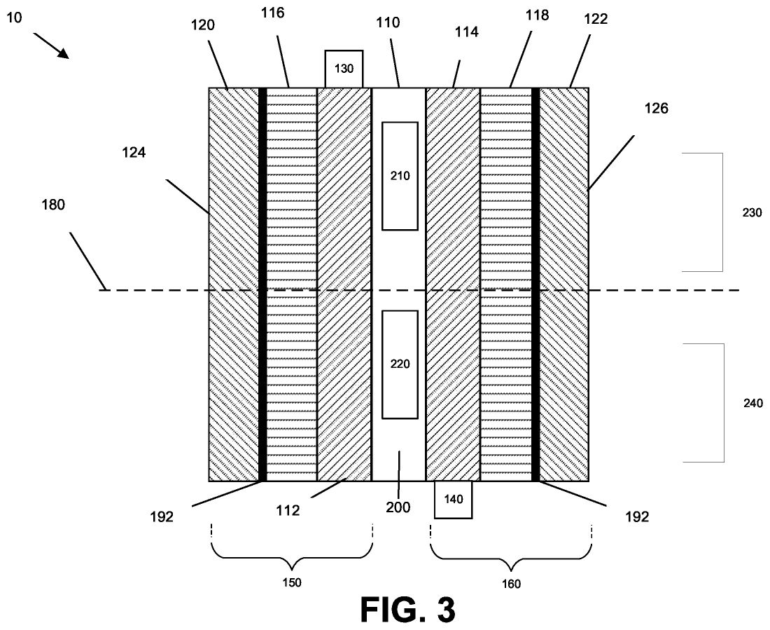

FIG. 1 depicts a privacy panel system 10. The privacy panel system 10 includes a privacy panel 100. In some embodiments, for example, the shape of the privacy panel 100 is circular, oval, triangular, square, rectangular, diamond, trapezoidal, parallelogram, rhombus, polygonal, and the like. In some embodiments, for example, the privacy panel 100 includes one or more edge portions. The number of edge portions depends on the shape of the privacy panel 100. In some embodiments, for example, where the privacy panel 100 has a round shape such as a circle or an oval, the privacy panel 100 has a continuous edge portion. In some embodiments, for example, where the privacy panel 100 has a polygonal shape, the privacy panel 100 has an edge portion for each side of the privacy panel 100. As depicted in FIG. 1, the privacy panel 100 has a rectangular shape, and has a first edge portion 102, a second edge portion 104, a third edge portion 106, and a fourth edge portion 108. While the privacy panel 100 is disposed in an operative orientation, the first edge portion 102 is a top edge portion, the second edge portion 104 is a bottom edge portion, the third edge portion 106 is a side edge portion, and the fourth edge portion 108 is a side edge portion. In some embodiments, for example, the length of the privacy panel 100 is measured between the first edge portion 102 and the second edge portion 104. In some embodiments, for example, the width of the privacy panel 100 is measured between the third edge portion 106 and the fourth edge portion 108. In some embodiments, for example, the thickness of the privacy panel 100 is measured along the longitudinal axis 180 as depicted in FIG. 3.

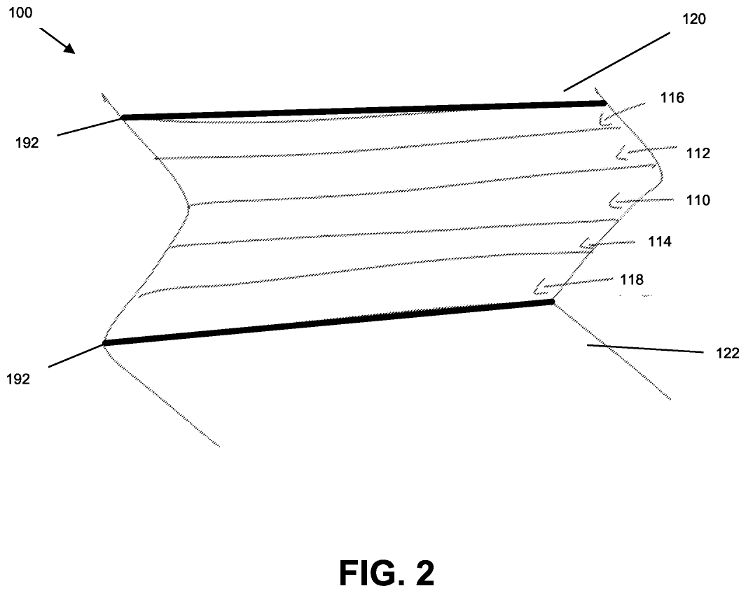

FIG. 2 depicts a schematic of the privacy panel 100 of the privacy panel system 10, and FIG. 3 is a cross-sectional view of the privacy panel 100 of the privacy panel system 10. As depicted in FIG. 2 and FIG. 3, the privacy panel 100 includes a transmittance layer 110, a first conductive layer 112, and a second conductive layer 114.

The first conductive layer 112 and the second conductive layer 114 are configured to define a voltage therebetween. In some embodiments, for example, the defined voltage is at least 20 VAC, for example, 30 VAC, for example, 40 VAC, for example 50 VAC, for example, 60 VAC, for example, 70 VAC. In some embodiments, for example the defined voltage is between 30 VAC and 65 VAC. In some embodiments, for example, while a voltage is defined between the first conductive layer 112 and the second conductive layer 114, an electrical field is generated or defined between the first conductive layer 112 and the second conductive layer 114.

The transmittance layer 110 has a transmittance that is responsive to an electrical field applied across the transmittance layer 110, for example, between the first conductive layer 112 and the second conductive layer 114. In some embodiments, for example, the transmittance of the transmittance layer 110 is variable in response to variations in an electrical field applied across the transmittance layer 110, for example, between the first conductive layer 112 and the second conductive layer 114. In some embodiments, for example, while a first electrical field is applied across the transmittance layer 110, the transmittance layer 110 has a first transmittance, and while a second electrical field is applied across the transmittance layer 110, the transmittance layer 110 has a second transmittance. In some embodiments, for example, while an electrical field is applied across the transmittance layer 110, the transmittance layer 110 has a first transmittance, and in the absence of application of the electrical field across the transmittance layer 110, the transmittance layer 110 has a second transmittance. The transmittance of the transmittance layer 110 is the fraction of incident electromagnetic power that is transmitted through the transmittance layer 110, for example, the ratio of transmitted optical power to the incident optical power for some object. In some embodiments, for example, the transmittance of the transmittance layer 110 is the amount of incident light that successfully passes through the transmittance layer 110.

In some embodiments, for example, the privacy panel 100 includes a first substrate layer 116 and a second substrate layer 118. In some embodiments, for example, the privacy panel 100 includes a first glass layer 120 and a second glass layer 122. In some embodiments, for example, as depicted in FIG. 2 and FIG. 3, the transmittance layer 110 is interposed between the first conductive layer 112 and the second conductive layer 114. In some embodiments, for example, the first substrate layer 116 is connected to the first conductive layer 112 opposite the transmittance layer 110, and the second substrate layer 118 is connected to the second conductive layer 114 opposite the transmittance layer 110. In some embodiments, for example, the first glass layer 120 is connected to the first substrate layer 116 opposite the first conductive layer 112. In some embodiments, for example, the second glass layer 112 is connected to the second substrate layer 118 opposite the second conductive layer 114. In some embodiments, for example, the first glass layer 120 is laminated to the first substrate layer 116 opposite the first conductive layer 112, for example, using laminating materials 192 such as ethylene-vinyl acetate (EVA) polyvinyl butyral (PVB), or thermoplastic polyurethane (TPU). In some embodiments, for example, the second glass layer 112 is laminated to the second substrate layer 118 opposite the second conductive layer 114, for example, using EVA, PVB, or TPU.

In some embodiments, for example, the privacy panel 100 includes a first supporting layer 150 and a second supporting layer 160. The first supporting layer 150 comprises the first conductive layer 112, the first substrate layer 116, and the first glass layer 120, and the second supporting layer 160 comprises the second conductive layer 114, the second substrate layer 118, and the second glass layer 122.

In some embodiments, for example, the transmittance layer 110 includes polymer-dispersed liquid crystal (PDLC). In some embodiments, for example, the transmittance layer 110 is made with PDLC. In some embodiments, for example, the first conductive layer 112 is made with indium tin oxide. In some embodiments, for example, the first conductive layer is an indium tin oxide coating on the first substrate layer 116. In some embodiments, for example, the second conductive layer 114 is made with indium tin oxide. In some embodiments, for example, the second conductive layer 114 is an indium tin oxide coating on the second substrate layer 118. In some embodiments, for example, the first substrate layer 116 and the second substrate layer 118 are made with polyethylene terephthalate (PET).

As depicted in FIGS. 1-4, the privacy panel system 10 comprises a first conductor 130 and a second conductor 140. The first conductor 130 and the second conductor 140 are configured to provide electrical power to the privacy panel 100. In some embodiments, for example, the first conductor 130 is electrically connected to or disposed in electrical communication with the privacy panel 100, for example, the first conductive layer 112, and the second conductor 140 is electrically connected to or disposed in electrical communication with the privacy panel 100, for example, the second conductive layer 114. In some embodiments, for example, the first conductor 130 is further electrically connected to or disposed in electrical communication with a power control system, which may include a power source, a transformer, a switch, and the like, and the second conductor 140 is electrically connected to or disposed in electrical communication with the power control system. In some embodiments, for example, one of the first conductor 130 and the second conductor 140 functions as the live conductor, and the other of the first conductor 130 and the second conductor 140 functions as the neutral conductor. In some embodiments, for example, while the first conductor 130 and the second conductor 140 are electrically connected to the first conductive layer 112 and the second conductive layer 114 and further electrically connected to the power control system, the privacy panel 100, for example, first conductive layer 112 and the second conductive layer 114, are electrically connected to or disposed in electrical communication with the power control system via the first conductor 130 and the second conductor 140

In some embodiments, for example, the first conductor 130 and the second conductor 140, and the first conductive layer 112 and the second conductive layer 114 are co-operatively configured such that, while the power control system is providing electrical power to the privacy panel 100 via the first conductor 130 and the second conductor 140, a voltage is defined between the first conductive layer 112 and the second conductive layer 114.

In some embodiments, for example, the first conductor 130 is connected to or disposed on a first edge portion 102 of the privacy panel 100, and the second conductor 140 is connected to or disposed on a second edge portion 104 of the privacy panel 100. In some embodiments, for example, the first edge portion 102 is offset from the second edge portion 104, as depicted in FIG. 1. In some embodiments, for example, the first edge portion 102 is parallel to the second edge portion 104, as depicted in FIG. 1. In some embodiments, for example, the first edge portion 102 and the second edge portion 104 are non-parallel. In some embodiments, for example, the first edge portion 102 is opposite to the second edge portion 104, as depicted in FIG. 1. In some embodiments, for example, the first edge portion 102 is opposite to and offset from the second edge portion 104, for example, opposite edge portions of a privacy panel 100 having a four-sided shape. In some embodiments, for example, the first edge portion 102 is opposite to and offset from the second edge portion 104, for example, a first edge portion and a third edge portion or a first edge portion and a fourth edge portion of a privacy panel 100 having a five-sided shape, where the first edge portion does not contact the third edge portion or the fourth edge portion, but is opposite to the third edge portion or the fourth edge portion. In some embodiments, for example, the first edge portion 102 is adjacent to the second edge portion 104. In some embodiments, for example, the first edge portion 102 and the second edge portion 104 meet at a corner of the privacy panel 100. In some embodiments, for example, at least one of the first edge portion 102 and the second edge portion 104 is curved. In some embodiments, for example, the first edge portion 102 and the second edge portion 104 are curved. In some embodiments, for example, the first edge portion 102 and the second edge portion 104 are defined by a curved edge of the privacy panel 100, the first edge portion 102 offset from the second edge portion 104.

In some embodiments, for example, the first conductor 130 includes a first bus bar 132 that is electrically connected to or disposed in electrical communication with the privacy panel 100, for example, the first conductive layer 112. In some embodiments, for example, the second conductor 140 includes a second bus bar 142 that is electrically connected to or disposed in electrical communication with the privacy panel 100, for example, the second conductive layer 114. In some embodiments, for example, as depicted in FIG. 1, the first bus bar 132 is connected to or disposed on the first edge portion 102 of the privacy panel 100, and the second bus bar 142 is connected to or disposed on a second edge portion 104 of the privacy panel 100.

In some embodiments, for example, the first bus bar 132 is secured to the privacy panel 100 by lamination. In some embodiments, for example, the second bus bar 142 is secured to the privacy panel 100 by lamination.

In some embodiments, for example, the first bus bar 132 is a copper bus bar or a carbon bus bar. In some embodiments, for example, the first bus bar 132 is a copper strip. In some embodiments, for example, the second bus bar 142 copper bus bar or a carbon bus bar. In some embodiments, for example, the second bus bar 142 is a copper strip. In some embodiments, the first bus bar 132 is connected to the first conductive layer 112 by soldering, and the second bus bar 142 is connected to the second conductive layer 114 by soldering. In some embodiments, the first bus bar 132 is connected to the first conductive layer 112 by a conductive adhesive, and the second bus bar 142 is connected to the second conductive layer 114 by a conductive adhesive.

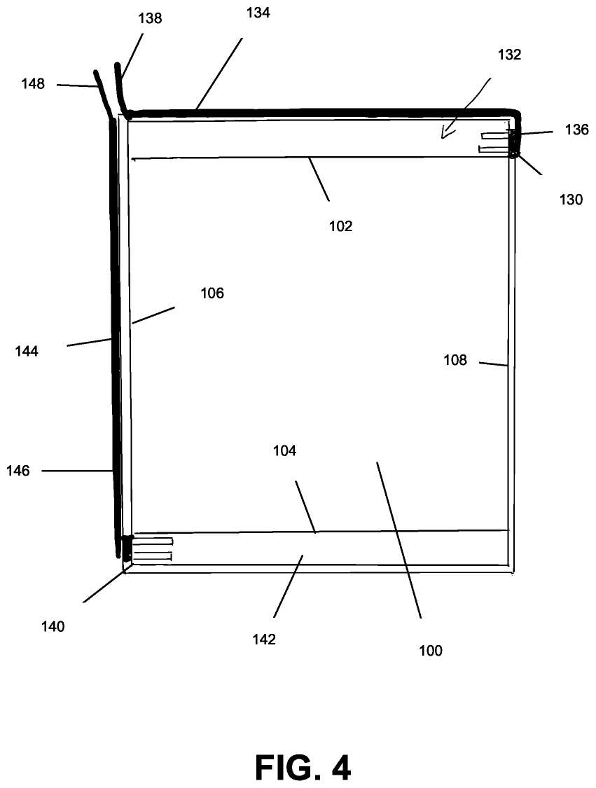

As depicted in FIG. 4, in some embodiments, for example, the first bus bar 132 extends along the first edge portion 102 of the privacy panel 100. In some embodiments, for example, the second bus bar 142 extends along the second edge portion 104 of the privacy panel 100.

In some embodiments, for example, the first conductor 130 includes a first flexible cable conductor 134 that is electrically connected to or disposed in electrical communication with the privacy panel, 100, for example, first conductive layer 112, and the first bus bar 130. In some embodiments, for example, the first flexible cable conductor 134 and the first conductive layer 112 are disposed in electrical communication via the first bus bar 132. In some embodiments, for example, the first flexible cable conductor 134 is a flat flexible cable conductor or a ribbon cable conductor. In some embodiments, for example, the second conductor 140 includes a second flexible cable conductor 144 conductor that is electrically connected to or disposed in electrical communication with the privacy panel 100, for example, the second conductive layer 114, and the second bus bar 142. In some embodiments, for example, the second flexible cable conductor 144 and the second conductive layer 114 are disposed in electrical communication via the second bus bar 142. In some embodiments, for example, the second flexible cable conductor 144 is a flat flexible cable conductor or a ribbon cable conductor.

As depicted in FIG. 1, in some embodiments, for example, the first flexible cable conductor 134 has a first end 136 and a second end 138, and the first end 136 of the first flexible cable conductor 134 is electrically connected to or disposed in electrical communication with the privacy panel 100, for example, the first conductive layer 112.

As depicted in FIG. 1, in some embodiments, for example, the second flexible cable conductor 144 has a first end 146 and a second end 148, and the first end 146 of the second flexible cable conductor 144 is electrically connected to or electrical communication with the privacy panel 100, for example, second conductive layer 114.

In some embodiments, for example, where the first bus bar 132 is a copper strip, the first flexible cable conductor 134, for example, the first end 136 of the first flexible cable conductor 134, is connected to the first bus bar 132 by soldering. In some embodiments, for example, where the second bus bar 142 is a copper strip, the second flexible cable conductor 144, for example, the first end 146 of the second flexible cable conductor 144, is connected to the second bus bar 142 by soldering.

As depicted in FIG. 4, in some embodiments, for example, the second end 138 of the first flexible cable conductor 134 and the second end 148 of the second flexible cable conductor 144 are disposed in an accessible condition while the privacy panel 100 is disposed in an operable orientation. In some embodiments, for example, while the second end 138 of the first flexible cable conductor 134 and the second end 148 of the second flexible cable conductor 144 are disposed in an accessible condition, the second end 138 of the first flexible cable conductor 134 and the second end 148 of the second flexible cable conductor 144 are reachable, useable, workable, exposed for access, and the like, for example, by a user, such as an operator, with relative ease. In some embodiments, for example, wiring to and from the power control system may be facilitated while the second end 138 of the first flexible cable conductor 134 and the second end 148 of the second flexible cable conductor 144 are disposed in the accessible condition, such that a user may connect the second end 138 of the first flexible cable conductor 134 and the second end 148 of the second flexible cable conductor 144 to the power control system to electrically communicate the power control system and the first conductive layer 112 and the second conductive layer 114.

In some embodiments, for example, to dispose the second end 138 of the first flexible cable conductor 134 and the second end 148 of the second flexible cable conductor 144 in the accessible condition, the second end 138 of the first flexible cable conductor 134 and the second end 148 of the second flexible cable conductor 144 are disposed such that two privacy panels 100 are disposable, for example, in abutting engagement, along opposing edge portions without inhibiting or impeding access to the second ends 138 of the first flexible cable conductors 134 and the second ends 148 of the second flexible cable conductors 144. In some embodiments, for example, the second end 138 of the first flexible cable conductor 134 and the second end 148 of the second flexible cable conductor 144 are disposed in the accessible condition such that inhibition or impediment of disposition of two privacy panels 100, for example, in abutting engagement, along opposing edge portions is absent. In some embodiments, for example, to dispose the second end 138 of the first flexible cable conductor 134 and the second end 148 of the second flexible cable conductor 144 in the accessible condition, the second end 138 of the first flexible cable conductor 134 and the second end 148 of the second flexible cable conductor 144 are disposed such that the first flexible cable conductor 134 and the second conductor 144 do not interfere with disposing two privacy panels 100, for example, in abutting engagement, along opposing edge portions. In some embodiments, for example, the second end 138 of the first flexible cable conductor 134 and the second end 148 of the second flexible cable conductor 144 are disposed in the accessible condition such that interference of disposition of two privacy panels 100, for example, in abutting engagement, along opposing edge portions is absent. In some embodiments, for example, as depicted in FIG. 4, to dispose the second end 138 of the first flexible cable conductor 134 and the second end 148 of the second flexible cable conductor 144 in the accessible condition, the second end 138 of the first flexible cable conductor 134 and the second end 148 of the second flexible cable conductor 144 are disposed at or near an end of the privacy panel 100, which, in some embodiments, is a top end of the privacy panel 100 while the privacy panel 100 is oriented in the operative orientation. As depicted in FIG. 4, in some embodiments, for example, the second end 138 of the first flexible cable conductor 134 and the second end 148 of the second flexible cable conductor 144 are disposed at or near a corner of the privacy panel 100, which, in some embodiments, is a top corner of the privacy panel 100 while the privacy panel 100 is oriented in the operative orientation. In some embodiments, for example, the second end 138 of the first flexible cable conductor 134 and the second end 148 of the second flexible cable conductor 144 are disposed at or near the same corner of the privacy panel 100. In some embodiments, for example, the second end 138 of the first flexible cable conductor 134 and the second end 148 of the second flexible cable conductor 144 are disposed at or near different corners of the privacy panel 100.

In some embodiments, for example, the first flexible cable conductor 134 is connected to the first edge portion 102 of the privacy panel 100 with conductive adhesive tape. In such embodiments, for example, the first bus bar 132 is the conductive adhesive tape that connects the first flexible cable conductor 134 to the first edge portion 102 of the privacy panel 100, such that the first flexible cable conductor 134 and the first conductive layer 112 are disposed in electrical communication via the conductive adhesive tape. At least one side of the conductive adhesive tape has an adhesive for connecting with the first conductive layer 112 to dispose the conductive adhesive tape and the first conductive layer 112 in electrical communication. In some embodiments, for example, a conductive paste, such as a conductive silver paste, is applied between the conductive adhesive tape and the first conductive layer 112, for example, on the first edge portion 102 of the privacy panel or on the surface of the conductive adhesive tape that connects with the first conductive layer 112, to improve conductivity between the conductive adhesive tape and the first conductive layer 112.

In some embodiments, for example, the second flexible cable conductor 144 is connected to the second edge portion 104 of the privacy panel 100 with conductive adhesive tape. In such embodiments, for example, the second bus bar 142 is the conductive adhesive tape that connects the second flexible cable conductor 144 to the second edge portion 104 of the privacy panel 100, such that the second flexible cable conductor 144 and the second conductive layer 114 are disposed in electrical communication via the conductive adhesive tape. At least one side of the conductive adhesive tape has an adhesive for connecting with the second conductive layer 114 to dispose the conductive adhesive tape and the second conductive layer 114 in electrical communication. In some embodiments, for example, a conductive paste, such as a conductive silver paste, is applied between the conductive adhesive tape and the second conductive layer 114, for example, on the second edge portion 104 of the privacy panel or on the surface of the conductive adhesive tape that connects with the second conductive layer 114, to improve conductivity between the conductive adhesive tape and the second conductive layer 114. In some embodiments, for example, the conductive tape is carbon-based conductive tape. In some embodiments, for example, the conductive tape is copper-based conductive tape. In some embodiments, for example, the conductive tape is conductive double-sided adhesive tape.

In some embodiments, for example, the first flexible cable conductor 134 extends along the first edge portion 102 of the privacy panel 100. As depicted in FIG. 4, in some embodiments, for example, at least a portion of the first flexible cable conductor 134 extends along the first edge portion 102 of the privacy panel 100. In some embodiments, for example, the second flexible cable conductor 144 extends along the second edge portion 104 of the privacy panel 100. In some embodiments, for example, at least a portion of the second flexible cable conductor 144 extends along the second edge portion 102 of the privacy panel 100. As depicted in FIG. 4, in some embodiments, for example, at least a portion of the second flexible cable conductor 144 extends along an edge portion of the privacy panel 100, said edge portion different from the edge portion of the privacy panel 100 on which at least a portion of the first flexible cable conductor 134 extends. For example, said edge portion on which at least a portion of the second flexible cable conductor 144 extends is a side edge portion of the privacy panel 100, such as the third edge portion 106 or the fourth edge portion 108. In some embodiments, for example, at least a portion of the second flexible cable conductor 144 extends along the second edge portion 102 and along a side edge portion of the privacy panel 100, such as the third edge portion 106 or the fourth edge portion 108. In some embodiments, for example, at least a portion of the second flexible cable conductor 144 extends along an edge portion of the privacy panel 100, said edge portion the same as the edge portion of the privacy panel 100 on which at least a portion of the first flexible cable conductor 134 extends. For example, said edge portion on which at least a portion of the second flexible cable conductor 144 extends is the first edge portion 102.

In some embodiments, for example, the first flexible cable conductor 134 is secured to the privacy panel 100 by lamination, for example, by EVA, PVB, or TPU. As depicted in FIG. 4, in some embodiments, for example, at least a portion of the first flexible cable conductor 134 is secured along the first edge portion 102 of the privacy panel 100 by lamination. In some embodiments, for example, the second flexible cable conductor 144 is secured to the privacy panel 100 by lamination, for example, by EVA, PVB, or TPU. In some embodiments, for example, at least a portion of the second flexible cable conductor 144 is secured along the second edge portion 102 of the privacy panel 100 by lamination. As depicted in FIG. 4, in some embodiments, for example, at least a portion of the second flexible cable conductor 144 is secured along an edge portion of the privacy panel 100 by lamination, said edge portion different from the edge portion of the privacy panel 100 on which at least a portion of the first flexible cable conductor 134 is secured. For example, said edge portion on which at least a portion of the second flexible cable conductor 144 is secured is a side edge portion of the privacy panel 100, such as the third edge portion 106 or the fourth edge portion 108. In some embodiments, for example, at least a portion of the second flexible cable conductor 144 is secured along an edge portion of the privacy panel 100 by lamination, said edge portion the same as the edge portion of the privacy panel 100 on which at least a portion of the first flexible cable conductor 134 is secured. For example, said edge portion on which at least a portion of the second flexible cable conductor 144 is secured is the first edge portion 102. In some embodiments, for example, while at least a portion of the first flexible cable conductor 134 and at least a portion of the second flexible cable conductor 144 are secured to edge portions of the privacy panel 100, the edges of the privacy panel system 10 defined by the edge portions of the privacy panel 100 and the at least a portion of the first flexible cable conductor 134 and at least a portion of the second flexible cable conductor 144 that are secured to the edge portions of the privacy panel 100 are substantially smooth, clean, and free of protrusions. In some embodiments, for example, at least a portion of the first flexible cable conductor 134 and at least a portion of the second flexible cable conductor 144 are secured to edge portions of the privacy panel 10, such that a first privacy panel system 10 and a second privacy panel system 10 may be disposed in abutting engagement, for example, vertically or horizontally, along opposing edges to connect the first privacy panel system 10 and the second privacy panel system 10.

In some embodiments, for example, to manufacture the privacy panel system 10, the transmittance layer 110, the first conductive layer 112, the second conductive layer 114, the first substrate layer 116, the second substrate layer 118, the first conductor 130, and the second conductor 140 are assembled together to define a PDLC film, with the first conductor 130 electrically connected to the first conductive layer 112, and the second conductor 140 electrically connected to the second conductive layer 114. In some embodiments, for example, the first flexible conductor 134 is electrically connected to the first conductive layer 112, for example, by soldering, conductive adhesive, or with conductive adhesive tape. In some embodiments, for example, the second flexible conductor 144 is electrically connected to the second conductive layer 114, for example, by soldering, conductive adhesive, or with conductive adhesive tape. In some embodiments, for example, liquid crystals are dissolved or dispersed into a liquid polymer. The liquid mixture of crystals and polymer is placed between the first substrate layer 116 having the first conductive layer 112 coating and the second substrate layer 118 and the second conductive layer 114 coating, which is then placed between the first glass layer 120 and the second glass layer 122, and then the polymer is solidified or cured. During the change of state of the polymer from a liquid to solid, the liquid crystals form droplets throughout the solid polymer, and are randomly oriented. The solidification or curing conditions affect the size of the droplets, which affects the operating properties of the privacy panel 100.

With the PDLC film defined, the first glass layer 120 and the second glass layer 122 are laminated to the PDLC film with laminate 192 to define the privacy panel 100, as depicted in FIG. 2 and FIG. 3. In some embodiments, for example, the first glass layer 120 is laminated to the first substrate material 116, with the laminating material, such as EVA, PVB, or TPU, interposed between the first glass layer 120 and the first substrate layer 116. In some embodiments, for example, the second glass layer 122 is laminated to second first substrate material 118, with the laminating material, such as EVA, PVB, or TPU, interposed between the second glass layer 122 and the second substrate layer 118.

In some embodiments, for example, where the first conductor 130 includes the first flexible cable conductor 134, the first flexible cable conductor 134 is laminated to the privacy panel 100 with laminating material 192, for example, with EVA, PVB, or TPU, to secure and adhere the first flexible cable conductor 134 to the privacy panel 100, as depicted in FIG. 2 and FIG. 3. In some embodiments, for example, a layer of conductive adhesive tape is first applied over the first flexible cable conductor 134 before application of the laminating material, such that the conductive adhesive tape is disposed between the first flexible cable conductor 134 and the laminating material. In some embodiments, for example, the first end 136 of the first flexible cable conductor 134 is electrically connected or disposed in electrical communication with the first conductive layer 112, at least a portion of the first flexible cable conductor 134 is secured along an edge portion, for example, the first edge portion 102, of the privacy panel 100 by lamination, and the second end 138 of the first flexible cable conductor 134 is disposed in the accessible condition. In some embodiments, for example, the first flexible cable conductor 134 is laminated to the first glass layer 120 and the second glass layer 122.

In some embodiments, for example, where the second conductor 140 includes the second flexible cable conductor 144, the second flexible cable conductor 144 is laminated to the privacy panel 100 with laminating materials 192, for example, with EVA, PVB, or TPU, to secure and adhere the second flexible cable conductor 144 to the privacy panel 100, as depicted in FIG. 2 and FIG. 3. In some embodiments, for example, a layer of conductive adhesive tape is first applied over the second flexible cable conductor 144 before application of the laminating material, such that the conductive adhesive tape is disposed between the second flexible cable conductor 144 and the laminating material. In some embodiments, for example, the first end 146 of the second flexible cable conductor 144 is electrically connected or disposed in electrical communication with the second conductive layer 114, at least a portion of the second flexible cable conductor 144 is secured along an edge portion, for example, the second edge portion 104, the third edge portion 106, or the fourth edge portion 108, of the privacy panel 100 by lamination, and the second end 148 of the second flexible cable conductor 144 is disposed in the accessible condition. In some embodiments, for example, the second flexible cable conductor 144 is laminated to the first glass layer 120 and the second glass layer 122.

In some embodiments, for example, lamination of the components of the privacy panel 100 is performed with an oven or an autoclave to control the temperature and pressure. In some embodiments, for example, prior to laminating the first flexible cable conductor 134 and the second flexible cable conductor 144 to the privacy panel 100, the first flexible cable conductor 134 and the second flexible cable conductor 144 are secured to the first glass layer 120 and the second glass layer 122, for example, with tape. After the lamination process is performed, the tape may be removed.

In some embodiments, for example, the length and width of the transmittance layer 110 is shorter, for example, a few millimeters shorter, than the corresponding length and width of the first and second glass layers 120 and 122. In some embodiments, for example, the first and second substrate layers 116 and 118 are bonded directly to each other along the perimeters of the first substrate layer 116 and the second substrate later 118 to seal the transmittance layer 110, the first conductive layer 112, and the second conductive, and to seal the panel 100. A portion of the first flexible cable conductor 134 and a portion of the second flexible cable conductor 144 configured for connecting to the first and second glass layers 120, 122 will be laminated to the one or more edges of the first and second glass layers 120, 122 that said portions of the first flexible cable conductor 134 and second flexible cable conductor 144 are touching. Once the laminate 192, for example EVA, PVB, or TPU, disposed between the first and second substrate 116, 118 and the first and second glass layers 120, 122 melts onto the edge of the glass layers 120 and 122 and onto the portions of the first flexible cable conductor 134 and the second flexible cable conductor 144 configured for contacting the first and second glass layers 120, 122 in the autoclave during the lamination procedure, said portions of the first flexible cable conductor 134 and the second flexible cable conductor 144 are connected to, for example, fused to, the one or more edges of the first and second glass layers 120, 122. The portions of the first and second flexible cable conductors 134, 144 which are not connected to the first and second glass layers 120, 122 are run in the frame in which the panel 100 is being installed to be disposed in the accessible condition.

In operation, the privacy panel 100 is electrically connected or disposed in electrical communication with a power control system, which may include a power source, a transformer, a switch, a quick disconnect, and the like, for example, by connecting the first conductor 130 and the second conductor 140 to the power control system. In some embodiments, for example, the privacy panel 100 is electrically connected or disposed in electrical communication with the power control system by connecting the second end 138 of the first conductor 130 and the second end 148 of the second conductor 140 to the power control system, while the first end 136 of the first conductor 130 is electrically connected to or disposed in electrical communication with the first conductive layer 112 and the first end 146 of the second conductor 140 is electrically connected to or disposed in electrical communication with the second conductive layer 114.

In the absence of electrical power supplied to the privacy panel 100 from the power control system, no electrical current flows from the first conductive layer 112 to the second conductive layer 114 and across the transmittance layer 110. The liquid crystal molecules dispersed in the polymer of the transmittance layer 110 are randomly oriented, such that the liquid crystal molecules are disposed in a configuration tending to refract, reflect, or otherwise scatter incident light. In some embodiments, for example, the ordinary refractive index of the liquid crystal dispersed in the polymer is different from that of the polymer, such that the incident light is scattered. In some embodiments, for example, in the absence of electrical power supplied to the privacy panel 100 from the power control system, the privacy panel 100 has a frosted or hazy aesthetic. In some embodiments, for example, in the absence of electrical power supplied to the privacy panel 100 from the power control system, a viewer may be able to detect that an object on the other side of the privacy panel 100, for example, by observing a faint profile of the object, but a viewer may be unable to view particular details of the object, for example, fine details, geometry, protrusions, cavities, or colour of the object. In this regard, in some embodiments, for example, the privacy panel 100 is effectively opaque. In some embodiments, for example, in the absence of electrical power supplied to the privacy panel 100 from the power control system, the transmittance layer 110 has a uniform transmittance of less than 20%, for example, less than 10%, for example, less than 5%.

In some embodiments, for example, the first conductor 130, the first conductive layer 112, the second conductor 140, and the second conductive layer 114 are co-operatively configured to generate an electrical field, for example, between the first conductive layer 112 and the second conductive layer 114 or across the transmittance layer 110. In some embodiments, for example, the first conductor 130, the first conductive layer 112, the second conductor 140, and the second conductive layer 114 are co-operatively configured to generate a uniform electrical field, for example, between the first conductive layer 112 and the second conductive layer 114 or across the transmittance layer 110.

While electrical power is supplied to the privacy panel 100 from the power control system, electrical current flows from the power control system, through the first conductor 130, for example, the first flexible cable conductor 134 and the first bus bar 132, to the first conductive layer 112, across the transmittance layer 110, to the second conductive layer 114, through the second conductor 140, for example, second bus bar 142 and the second flexible cable conductor 144, and to the power control system. While electrical power is supplied to the privacy panel 100 from the power control system, a voltage is defined between the first conductive layer 112 and the second conductive layer 114, and an electrical field is generated across the transmittance layer 110.

In some embodiments, for example, the first conductor 130, the first conductive layer 112, the second conductor 140, the second conductive layer 114, and the transmittance layer 110 are co-operatively configured such that, while the electrical field is applied across the transmittance layer 110, the transmittance layer 110 has a uniform transmittance. In some embodiments, for example, the first conductor 130, the first conductive layer 112, the second conductor 140, the second conductive layer 114, and the transmittance layer 110 are co-operatively configured such that, while the electrical field is applied across the transmittance layer 110, the privacy panel 100 has a uniform transmittance. In some embodiments, for example, the first conductor 130, the first conductive layer 112, the second conductor 140, the second conductive layer 114, and the transmittance layer 110 are co-operatively configured such that the transmittance layer 110 has a uniform transmittance in response to generation of the electrical field, such as the uniform electrical field, between the first conductive layer 112 and the second conductive layer 114.

In some embodiments, for example, the first conductor 130, the first conductive layer 112, the second conductor 140, and the second conductive layer 114 are co-operatively configured to generate a uniform electrical field between the first conductive layer 112 and the second conductive layer 114 or across the transmittance layer 110. In some embodiments, for example, the first conductor 130, the first conductive layer 112, the second conductor 140, the second conductive layer 114, and the transmittance layer 110 are co-operatively configured such that the transmittance layer 110 has a uniform transmittance in response to generation of the uniform electrical field between the first conductive layer 112 and the second conductive layer 114. In some embodiments, for example, the first conductor 130, the first conductive layer 112, the second conductor 140, the second conductive layer 114, and the transmittance layer 110 are co-operatively configured such that the privacy panel 100 has a uniform transmittance in response to generation of the uniform electrical field between the first conductive layer 112 and the second conductive layer 114.

While electrical power is supplied to the privacy panel 100 from the power control system, electrical current flows from the first conductive layer 112 to the second conductive layer 114 and across the transmittance layer 110, such that a voltage is defined between the first conductive layer 112 and the second conductive layer 114 and an electrical field is generated across the transmittance layer 110. In response to the generated electrical field, the randomly oriented liquid crystal molecules dispersed in the polymer of the transmittance layer 110 become polarized and arranged in alignment, such that the liquid crystal molecules are disposed in a configuration tending to transmit more incident light through the transmittance layer 110 and through the privacy panel 100, relative to privacy panel 100 while there is an absence of electrical power supplied to the privacy panel 100. While the liquid crystal molecules are arranged in alignment, the refractive index of the liquid crystal dispersed in the polymer is the same, or substantially the same, as that of the polymer, such that more incident light may transit through the transmittance layer 110 and through the privacy panel 100. In some embodiments, for example, while electrical power is supplied to the privacy panel 100 from the power control system, the privacy panel 100 has a clear aesthetic. In some embodiments, for example, while electrical power is supplied to the privacy panel 100 from the power control system, a viewer may be able to view an object on the other side of the privacy panel 100, for example, by observing particular details of the object, for example, fine details, geometry, protrusions, cavities, or colour of the object. In this regard, in some embodiments, for example, the privacy panel 100 is effectively translucent. In some embodiments, for example, while electrical power is supplied to the privacy panel 100 from the power control system, the transmittance layer 110 has a uniform transmittance of at least 66%, for example, at least 72%, for example, at least 75%.

In some embodiments, for example, the transmittance of the transmittance layer 110 is responsive to the electrical field across the transmittance layer 110. In some embodiments, for example, the transmittance is controllable by varying the voltage applied across the first conductive layer 112 and the second conductive layer 114, or by varying the electrical field across the transmittance layer 110. In some embodiments, for example, while a relatively low voltage is applied across the first conductive layer 112 and the second conductive layer 114 such that a weaker electrical field is generated across the transmittance layer 110, a relatively low number of liquid crystals become polarized and arranged in alignment, such that less incident light is transmitted through the transmittance layer 110 and the privacy panel 100 and relatively more light is scattered by the liquid crystals in the transmittance layer 110. In some embodiments, for example, while a relatively high voltage is applied across the first conductive layer 112 and the second conductive layer 114 such that a stronger electrical field is generated across the transmittance layer 110, a relatively high number of liquid crystals become polarized and arranged in alignment, such that more incident light is transmitted through the transmittance layer 110 and the privacy panel 100 and relatively less light is scattered by the liquid crystals in the transmittance layer 110. In some embodiments, for example, the transmittance layer 110 functions as a selective light scattering layer that is configured to selectively scatter incident light and to selectively transmit incident light therethrough.

In some embodiments, for example, the first conductor 130, the first conductive layer 112, the second conductor 140, the second conductive layer 114, and the transmittance layer 110 are co-operatively configured such that, while the electrical field is generated between the first conductive layer 112 and the second conductive layer 114, between two spaced-apart regions of the transmittance layer 110, the difference in transmittance is visibly indiscernible, for example, to the naked eye. In some embodiments, for example, the first conductor 130, the first conductive layer 112, the second conductor 140, the second conductive layer 114, and the transmittance layer 110 are co-operatively configured such that, while the electrical field is generated across the transmittance layer 110, between two spaced-apart regions of the transmittance layer 110, the difference in transmittance is visibly indiscernible, for example, to the naked eye. In some embodiments, for example, the first conductor 130, the first conductive layer 112, the second conductor 140, the second conductive layer 114, and the transmittance layer 110 are co-operatively configured such that, while the voltage is applied between the first conductive layer 112 and the second conductive layer 114, between two spaced-apart regions, for example, a first region 210 and a second region 220, of the transmittance layer 110, the difference in transmittance is visibly indiscernible, for example, to the naked eye. FIG. 3 depicts a first region 210 and a second region 220 of the transmittance layer 110. In some embodiments, for example, the first region 210 and the second region 220 are spaced apart length-wise or width-wise. FIG. 3 depicts the first region 210 and the second region 220 being vertically spaced apart. In some embodiments, for example, the first region 210 and the second region 220 are horizontally spaced apart, diagonally spaced apart, or otherwise spaced apart.

In some embodiments, for example, the first conductor 130, the first conductive layer 112, the second conductor 140, the second conductive layer 114, and the transmittance layer 110 are co-operatively configured such that, while the electrical field is generated between the first conductive layer 112 and the second conductive layer 114, between two spaced-apart regions of the privacy panel 100, the difference in transmittance is visibly indiscernible, for example, to the naked eye. In some embodiments, for example, the first conductor 130, the first conductive layer 112, the second conductor 140, the second conductive layer 114, and the transmittance layer 110 are co-operatively configured such that, while the electrical field is generated across the transmittance layer 110, between two spaced-apart regions of the privacy panel 100, the difference in transmittance is visibly indiscernible, for example, to the naked eye. In some embodiments, for example, the first conductor 130, the first conductive layer 112, the second conductor 140, the second conductive layer 114, and the transmittance layer 110 are co-operatively configured such that, while the voltage is applied between the first conductive layer 112 and the second conductive layer 114, between two spaced-apart regions, for example, a first region 230 and a second region 240, of the privacy panel 100, the difference in transmittance is visibly indiscernible, for example, to the naked eye. FIG. 3 depicts a first region 230 and a second region 240 of the privacy panel 100. In some embodiments, for example, the first region 230 and the second region 240 are spaced apart length-wise or width-wise. FIG. 3 depicts the first region 230 and the second region 240 being vertically spaced apart. In some embodiments, for example, the first region 230 and the second region 240 are horizontally spaced apart, diagonally spaced apart, or otherwise spaced apart.

In some embodiments, for example, where the power control system provides AC power, during operation of the privacy panel 100, electrical current may: 1) flow from the power control system, to the first conductor 130, to the second conductor 140, and back to the power control system, or 2) flow from the power control system, to the second conductor 140, to the first conductor 130, and back to the power control system.

In some embodiments, for example, the privacy panel 100 defines a longitudinal axis 180, as depicted in FIG. 3. In some embodiments, for example, the longitudinal cross-section of the privacy panel 100 is perpendicular to the longitudinal axis 180. In some embodiments, for example, the longitudinal axis 180 is perpendicular to the first outer surface 124 and the second outer surface 126 of the panel 100. In some embodiments, for example, the first outer surface 124

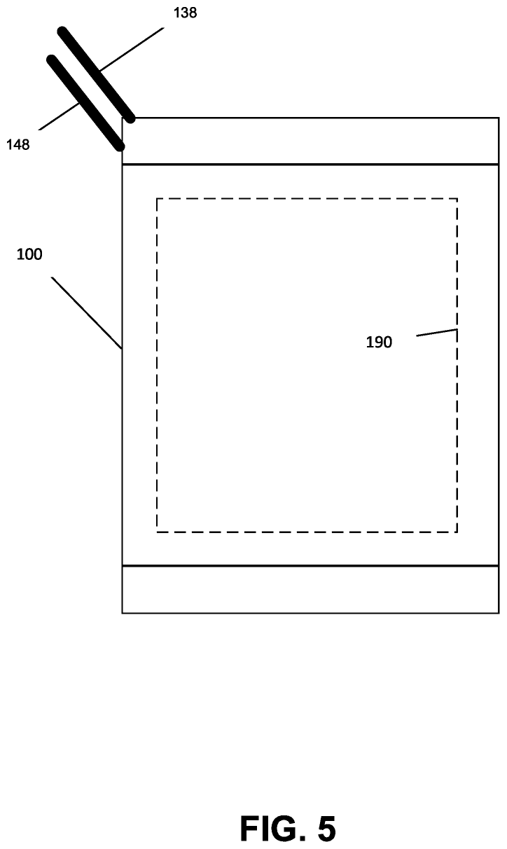

In some embodiments, for example, as depicted in FIG. 5, the privacy panel 100 defines a uniform transmittance privacy panel portion 190, the uniform transmittance privacy panel portion 190 having the uniform transmittance while the electrical field is applied across the transmittance layer 110. In some embodiments, for example, a cross-sectional area of the uniform transmittance privacy panel portion 190 defines at least 90%, for example, at least 95%, for example, at least 99%, of a total cross-sectional area of the privacy panel 100. In some embodiments, for example, the uniform transmittance privacy panel portion 190 has a minimum cross-sectional area of 16 square inches. In some embodiments, for example, the uniform transmittance privacy panel portion 190 has a cross-sectional area of at least 16 square inches, for example, 72 square inches, for example, 288 square inches, for example, 2700 square inches, for example, 8208 square inches, for example, 15552 square inches.

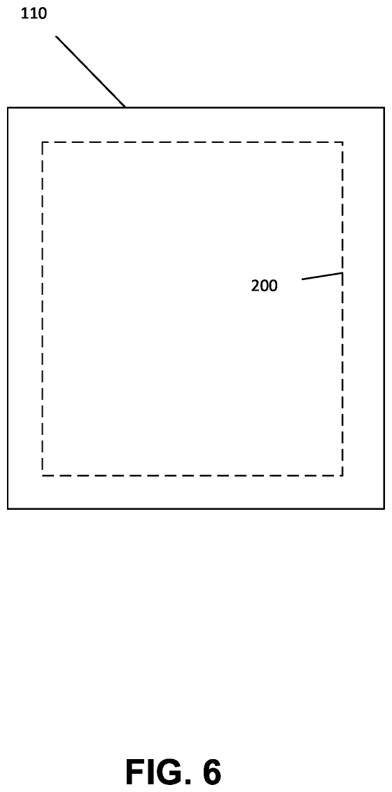

In some embodiments, for example, as depicted in FIG. 6, the transmittance layer 110 defines a uniform transmittance layer portion 200, the uniform transmittance layer portion 200 having the uniform transmittance while the electrical field is applied across the transmittance layer 110. In some embodiments, for example, a cross-sectional area of the uniform transmittance layer portion 200 defines at least 90%, for example, at least 95%, for example, at least 99%, of a total cross-sectional area of the transmittance layer 110. In some embodiments, for example, the uniform transmittance layer portion 200 has a minimum cross-sectional area of 16 square inches. In some embodiments, for example, the uniform transmittance layer portion 200 has a cross-sectional area of at least 16 square inches, for example, 72 square inches, for example, 288 square inches, for example, 2700 square inches, for example, 8208 square inches, for example, 15552 square inches.

In some embodiments, for example, the privacy panel system 10 comprises the privacy panel 100 including a continuous privacy panel portion 170 and a viewing surface, for example, the first surface 124 or the first surface 126 as depicted in FIG. 1 and FIG. 3. In some embodiments, for example, the continuous privacy panel portion 170 includes an operative viewing surface portion 172 of the viewing surface. The continuous privacy panel portion 170 is configurable in a first configuration and a second configuration. The privacy panel system 10 further includes an electrical field generator. In some embodiments, for example, the electrical field generator generates an electrical field across at least a portion of the continuous privacy panel portion 170. While the continuous privacy panel portion 170 is disposed in the first configuration, the continuous privacy panel portion 170 has a first uniform transmittance. While the continuous privacy panel portion 170 is disposed in the second configuration, the continuous privacy panel portion 170 has a second uniform transmittance. In some embodiments, for example, the transition between the first configuration and the second configuration of the continuous privacy panel portion 170 is effectible in response to a change in the electrical field generated by the electrical field generator. In some embodiments, for example, a surface area of the operative viewing surface portion 172 defines at least 90% of a total surface area of the viewing surface. In some embodiments, for example, a surface area of the operative viewing surface portion 172 defines at least 95% of a total surface area of the viewing surface. In some embodiments, for example, a surface area of the operative viewing surface portion 172 defines at least 99% of a total surface area of the viewing surface.

In some embodiments, for example, while the continuous privacy panel portion 170 is disposed in the first configuration, between two spaced-apart regions of the continuous privacy panel portion 170, the difference in transmittance is visibly indiscernible.

In some embodiments, for example, while the continuous privacy panel portion 170 is disposed in the second configuration, between two spaced-apart regions of the continuous privacy panel portion 170, the difference in transmittance is visibly indiscernible.

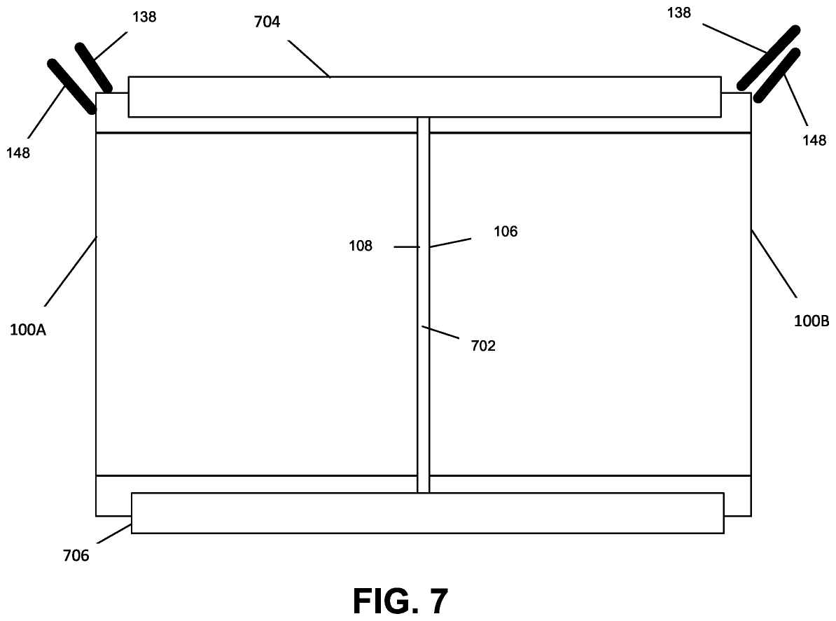

In some embodiments, for example, as depicted in FIG. 7, two privacy panels 100A and 100B are configured to be joined together, for example, in a butt-joined configuration. The first and second privacy panels 100A and 100B are disposed such that an edge portion of the first privacy panel 100A is disposed in opposition to a corresponding edge portion of the second privacy panel 100B, and that the second end 138 of the first flexible cable conductor 134 and the second end 148 of the second flexible cable conductor 144 of the first privacy panel 100A and the second privacy panel 100B are disposed in an accessible condition. As depicted, in some embodiments, for example, the fourth edge portion 108 of the first privacy panel 100A is disposed in opposition to the third edge portion 106 of the second privacy panel 100B. In some embodiments, for example, the first privacy panel 100A and the second privacy panel 100B are relatively disposed such that a gap 702 is defined between the first privacy panel 100A and the second privacy panel 100B. In some embodiments, for example, while the edge portion of the first privacy panel 100A is disposed in opposition to the corresponding edge portion of the second privacy panel 100B, the first privacy panel 100A and the second privacy panel 100B are secured by upper and lower frame members 704 and 706. In some embodiments, for example, as depicted in FIG. 7, while the first privacy panel 100A and the second privacy panel 100B are secured by the upper frame member 704, a portion, for example, an upper portion of the first privacy panel 100A and a portion, for example, an upper portion, of the second privacy panel 100B are received in the upper frame member 704. In some embodiments, for example, as depicted in FIG. 7, while the first privacy panel 100A and the second privacy panel 100B are secured by the lower frame member 706, a portion, for example, a lower portion of the first privacy panel 100A and a portion, for example, a lower portion, of the second privacy panel 100B are received in the lower frame member 706. With the first privacy panel 100A and the second privacy panel 100B secured, the gap 702 is filled with silicone or plastic rubber to butt-join the first privacy panel 100A and the second privacy panel 100B.

In some embodiments, for example, a portion of the first flexible cable conductor 134 that is connected of the top edges of the first and second glass layer 120, 122 is laminated to said edges. In some embodiments, for example, a portion of the second flexible cable conductor 144 that is connected of the bottom edges of the first and second glass layer 120, 122 is laminated to said edges. In some embodiments, for example, the upper and lower frame members 704 and 706 include a rubber gasket to protect the portion of the first and second flexible cable conductors 134, 144 laminated to the top and bottom ledges of the panel 100 such that said portions of the first and second flexible cable conductors 134, 144 are not disposed in contact with another conductive item. In some embodiments, for example, silicon or plastic rubber is applied on the vertical edges, such as the third edge portion 106 and the fourth edge portion 108, to protect the flexible cable conductors and prevents interference.

In some embodiments, for example, with the second end 138 of the first flexible cable conductor 134 and the second end 148 of the second flexible cable conductor 144 of the first privacy panel 100A and the second privacy panel 100B disposed in an accessible condition, electrical communication between the first privacy panel 100A and the second privacy panel 100B may be established via wiring to and from the power control system

A method of using a privacy panel system is disclosed. The privacy panel system 10 comprises a privacy panel 100, comprising a first conductive layer 112, a second conductive layer 114, a transmittance layer 110 between the first conductive layer 112 and the second conductive layer 114, the transmittance layer 100 having a transmittance that is responsive to an electrical field between the first conductive layer 112 and the second conductive layer 114. The privacy panel system 10 further comprises a first conductor 130 electrically connected to the first conductive layer 112, and a second conductor 140 electrically connected to the second conductive layer 114. The first conductor 130, the first conductive layer 112, the second conductor 140, the second conductive layer 114, and the transmittance layer 110 are co-operatively configured such that, while the electrical field is applied across the transmittance layer 110, the transmittance layer 100 has a uniform transmittance. The method comprises generating the electrical field across the transmittance layer 110, such that the transmittance layer 110 has the uniform transmittance.

In some embodiments, for example, the privacy panel system 10 provides a more uniform voltage between the first conductive layer 112 and the second conductive layer 114 and a more uniform electrical field generated across the transmittance layer 110, such that haziness of the privacy panel 100 due to inconsistent voltage between the first conductive layer 112 and the second conductive layer 114 or inconsistent electrical field across the transmittance layer 110. In some embodiments, for example, a more uniform voltage between the first conductive layer 112 and the second conductive layer 114 and a more uniform electrical field generated across the transmittance layer 110 reduces degradation of the PDLC material, and such degradation of the PDLC material will be more uniform.

In some embodiments, for example, because of a more uniform voltage between the first conductive layer 112 and the second conductive layer 114 and a more uniform electrical field generated across the transmittance layer 110, the size of the privacy panel 100 of the privacy panel system 10 may be relatively large. In some embodiments, for example, the ratio between the length and width of the privacy panel 100 is at least 1 to 1, for example, 2 to 1, for example, 3 to 1. In some embodiments, for example, the privacy panel 100 has a length of at least 4 inches. In some embodiments, the privacy panel 100 has a width of at least 4 inches. In some embodiments, for example, the size of the privacy panel 100 is 24 inches by 12 inches. In some embodiments, for example, the size of the privacy panel 100 is 90 inches in length and 30 inches in width. In some embodiments, for example, the size of the privacy panel 100 is 96 inches in length and 48 inches in width. In some embodiments, for example, the size of the privacy panel 100 is 120 inches in length and 60 inches in width. In some embodiments, for example, the size of the privacy panel 100 is 114 inches in length and 72 inches in width. In some embodiments, for example, the size of the privacy panel 100 is 216 inches in length and 72 inches in width.

In some embodiments, for example, where the first conductor 130, for example, the first bus bar 132 or the first flexible cable conductor 134, are laminated to the privacy panel 100, the first conductor 130 resists removal from the privacy panel 100, which reduces the risk that the first flexible cable conductor 134 is pulled out, thereby reducing the risk of irreparably damaging the privacy panel system 10. In some embodiments, for example, where the second conductor 140, for example, the second bus bar 142 or the second flexible cable conductor 144, are laminated to the privacy panel 100, the second conductor 140 resists removal from the privacy panel 100, which reduces the risk that the first flexible cable conductor 144 is pulled out, thereby reducing the risk of irreparably damaging the privacy panel system 10.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be examples only. The invention is defined by the appended claims.

1-111. (canceled)

112. A privacy panel system, comprising:
a privacy panel, comprising:
a first conductive layer;
a second conductive layer;
a transmittance layer between the first conductive layer and the second conductive layer, the transmittance layer having a transmittance that is responsive to an electrical field between the first conductive layer and the second conductive layer;
a first conductor electrically connected to the first conductive layer;
a second conductor electrically connected to the second conductive layer;
wherein the first conductor, the first conductive layer, the second conductor, the second conductive layer, and the transmittance layer are co-operatively configured such that, while the electrical field is applied across the transmittance layer, the transmittance layer has a uniform transmittance.

113. The privacy panel system of claim 112, wherein:
the first conductor, the first conductive layer, the second conductor, the second conductive layer, and the transmittance layer are co-operatively configured such that, while the electrical field is generated between the first conductive layer and the second conductive layer, between two spaced-apart regions of the transmittance layer, the difference in transmittance is visibly indiscernible.

114. The privacy panel system of claim 112, wherein the first conductor is connected to a first edge portion of the privacy panel, and the second conductor is connected to a second edge portion of the privacy panel.

115. The privacy panel system of claim 114, wherein the first edge portion is offset from the second edge portion.

116. The privacy panel system of claim 112, wherein the first conductor includes a first bus bar that is electrically connected to the first conductive layer, and the second conductor includes a second bus bar that is electrically connected to the second conductive layer.

117. The privacy panel system of claim 112, wherein the first conductor includes a first flexible cable conductor that is electrically connected to the first conductive layer and the first bus bar, and the second conductor includes a second flexible cable conductor that is electrically connected to the second conductive layer and the second bus bar.

118. The privacy panel system of claim 117, wherein:
the first flexible cable conductor has a first end and a second end, wherein the first end of the first flexible cable conductor is electrically connected to the first conductive layer;
the second flexible cable conductor has a first end and a second end, wherein the first end of the second flexible cable conductor is electrically connected to the second conductive layer; and
the second end of the first flexible cable conductor and the second end of the second flexible cable conductor are disposed in an accessible condition while the privacy panel is disposed in an operable orientation.

119. A privacy panel system, comprising:
a privacy panel, comprising:
a first conductive layer,
a second conductive layer,
a transmittance layer between the first conductive layer and the second conductive layer, the transmittance layer having a transmittance response to an electrical field between the first conductive layer and the second conductive layer;
a first conductor electrically connected to the first conductive layer;
a second conductor electrically connected to the second conductive layer;
the first conductor, the first conductive layer, the second conductor, and the second conductive layer are co-operatively configured to generate a uniform electrical field between the first conductive layer and the second conductive layer.

120. The privacy panel system of claim 119, wherein:
the first conductor, the first conductive layer, the second conductor, the second conductive layer, and the transmittance layer are co-operatively configured such that the transmittance layer has a uniform transmittance in response to generation of the uniform electrical field between the first conductive layer and the second conductive layer.

121. The privacy panel system of claim 119, wherein:
the first conductor, the first conductive layer, the second conductor, the second conductive layer, and the transmittance layer are co-operatively configured such that, while the electrical field is generated between the first conductive layer and the second conductive layer, between two spaced-apart regions of the transmittance layer, the difference in transmittance is indiscernible.

122. The privacy panel system of claim 119, wherein:
the first conductor is connected to a first edge portion of the privacy panel, and the second conductor is connected to a second edge portion of the privacy panel; and
the first edge portion is offset from the second edge portion.

123. The privacy panel system of claim 119, wherein:
the first conductor includes:
a first bus bar that is electrically connected to the first conductive layer; and
a first flexible cable conductor that is electrically connected to the first conductive layer and the first bus bar; and
the second conductor includes:
the second conductor includes a second bus bar that is electrically connected to the second conductive layer; and
a second flexible cable conductor that is electrically connected to the second conductive layer and the second bus bar.

124. The privacy panel system of claim 123, wherein:
the first flexible cable conductor has a first end and a second end, wherein the first end of the first flexible cable conductor is electrically connected to the first conductive layer;
the second flexible cable conductor has a first end and a second end, wherein the first end of the second flexible cable conductor is electrically connected to the second conductive layer; and
the second end of the first flexible cable conductor and the second end of the second flexible cable conductor are disposed in an accessible condition while the privacy panel is disposed in an operable orientation.

125. A privacy panel system, comprising:
a privacy panel including a continuous privacy panel portion and a viewing surface;
the continuous privacy panel portion including an operative viewing surface portion of the viewing surface;
the continuous privacy panel portion configurable in a first configuration and a second configuration;
an electrical field generator;
wherein:
while the continuous privacy panel portion is disposed in the first configuration, the continuous privacy panel portion has a first uniform transmittance;
while the continuous privacy panel portion is disposed in the second configuration, the continuous privacy panel portion has a second uniform transmittance;
the transition between the first configuration and the second configuration is effectible in response to a change in the electrical field; and
a surface area of the operative viewing surface portion defines at least 90% of a total surface area of the viewing surface.

126. The privacy panel system of claim 125, wherein the surface area of the operative viewing surface portion defines at least 99% of a total surface area of the viewing surface.

127. The privacy panel system of claim 125, wherein:
while the continuous privacy panel portion is disposed in the first configuration, between two spaced-apart regions of the continuous privacy panel portion, the difference in transmittance is visibly indiscernible; and
while the continuous privacy panel portion is disposed in the second configuration, between two spaced-apart regions of the continuous privacy panel portion, the difference in transmittance is visibly indiscernible.

128. The privacy panel system of claim 125, comprising:
a first conductor electrically connected to the privacy panel;
a second conductor electrically connected to the privacy panel;
wherein the first conductor is connected to a first edge portion of the privacy panel, and the second conductor is connected to a second edge portion of the privacy panel, and the first edge portion is offset from the second edge portion.

129. The privacy panel system of claim 128, wherein:
the first conductor includes:
a first bus bar that is electrically connected to the privacy panel, and a first flexible cable conductor that is electrically connected to the privacy panel and the first bus bar,
the second conductor includes:
a second bus bar that is electrically connected to the privacy panel, and a second flexible cable conductor that is electrically connected to the privacy panel and the second bus bar.

130. The privacy panel system of claim 129, wherein:
the first flexible cable conductor has a first end and a second end, wherein the first end of the first flexible cable conductor is electrically connected to the privacy panel;
the second flexible cable conductor has a first end and a second end, wherein the first end of the second flexible cable conductor is electrically connected to the privacy panel; and
the second end of the first flexible cable conductor and the second end of the second flexible cable conductor are disposed in an accessible condition while the privacy panel is disposed in an operable orientation.

131. A method of using a privacy panel system, the privacy panel system comprising a privacy panel that comprises a first conductive layer, a second conductive layer, a transmittance layer between the first conductive layer and the second conductive layer, the transmittance layer having a transmittance that is responsive to an electrical field between the first conductive layer and the second conductive layer, a first conductor electrically connected to the first conductive layer, a second conductor electrically connected to the second conductive layer, the method comprising:
applying a potential to the first and second conductive layers to generate an electrical field across the transmittance layer, such that the transmittance layer has a uniform transmittance.
